(19) United States
(12) Patent Application Publication
(10) Pub. No.: US 2011/0204710 A1
(43) Pub. Date: Aug. 25, 2011

(54) BRAKE PRESSURE CONTROL APPARATUS WHICH REGULATES DECELERATION RATE WHILE BRAKING ACCORDING TO BRAKE PRESSURE AND METHOD THEREOF

(76) Inventor: Won-Bae Lee, Seoul (KR)

(21) Appl. No.: 13/127,396

(22) PCT Filed: Jun. 24, 2009
(86) PCT No.: PCT/KR2009/003395

§ 371 Date: May 3, 2011

(30) Foreign Application Priority Data
Nov. 3, 2008 (KR) 10-2008-0108197

(51) Int. Cl. B60T 8/34

(52) U.S. Cl. 303/119.1; 303/20

(57) ABSTRACT

Disclosed a brake pressure control apparatus including a cylinder of which an upper portion is formed with a connection port connected with a brake line and a lower surface is formed with an air inlet/outlet port; a piston which is supported by a first spring disposed at a bottom surface of the cylinder; an opening/closing plate which is fixed to an upper portion of the piston so as to divide an inner portion of the cylinder and in which a fluid passage is formed at a center portion thereof; an introduction control valve which is disposed at an upper portion of the fluid passage H formed at the opening/closing plate so as to control a flow of the brake fluid introduced into the cylinder according to a brake pressure; a fluid passage opening/closing unit which is disposed at an inner portion of the opening/closing plate, and comprises a permanent magnet provided at one side thereof, a movement spring provided at the other side thereof and an opening/closing member disposed between the permanent magnet and the movement spring so as to be intersected with the fluid passage, thereby opening and closing the fluid passage; a brake fluid outlet port which is formed at both sides of the fluid passage formed at the opening/closing plate so as to provide a passage through which the brake fluid in the cylinder is discharged; and an electromagnet which is disposed at an outer circumference of the cylinder so as to be corresponding to the permanent magnet of the fluid passage opening/closing unit and also connected with a vehicle speed sensor.

### TECHNICAL FIELD

The present invention relates to a brake pressure control apparatus which regulates a decompression rate according to a brake pressure upon braking, and a method thereof, and more particularly to a brake pressure control apparatus which regulates a decompression rate according to a brake pressure upon braking, in which a forward inertial force generated when a vehicle is stopped and a backward repulsive force generated by restoring force of a suspension system are exhausted upon ordinary braking by using a brake pressure control method, and they are offset upon sudden braking by using the brake pressure control method, and a method thereof.

### BACKGROUND ART

Generally, in order to reduce a braking shock generated when braking a vehicle, most drivers artificially manipulates a brake pedal so as to control a brake pressure. However, in the artificial manipulation of the brake pedal, since a manipulation time point and a force necessary for the manipulation are not uniform all the time, the effect of reducing the braking shock is not satisfactory, and the drivers feel tired due to pedal manipulation.

To solve the problems, a study on a mechanical method of reducing the braking shock, instead of the driver's artificial manipulation, has been continuously carried out. However, until now, there have been developed only a solution to the problem of a sudden braking state which is occurred for a moment of time just before the stopping of the vehicle, and a piecemeal control method without considering a property of the restoring force of the suspension system.

As the result, there is a problem that the brake pressure is decompressed in a state that a new inertial force is generated again after controlling the brake pressure or the braking shock is already occurred, thereby deteriorating the effect of reducing the braking shock.

### DISCLOSURE

### Technical Problem

An object of the present invention is to provide a brake pressure control apparatus which regulates a decompression rate according to a brake pressure upon braking so as to obtain a braking speed (time) which exhausts a forward inertial force and backward repulsive force generated when a vehicle is stopped upon ordinary braking by using a brake pressure control method and also offsets them by the brake pressure control method upon sudden braking, and a method thereof.

### Technical Solution

To achieve the object of the present invention, the present invention provides a brake pressure control apparatus including a cylinder of which an upper portion is formed with a connection port connected with a brake line and a lower surface is formed with an air inlet/outlet port; a piston which is supported by a first spring disposed at a bottom surface of the cylinder; an opening/closing plate which is fixed to an upper portion of the piston so as to divide an inner portion of the cylinder and in which a fluid passage is formed at a center portion thereof; an introduction control valve which is disposed at an upper portion of the fluid passage H formed at the opening/closing plate so as to control a flow of the brake fluid introduced into the cylinder according to a brake pressure; a fluid passage opening/closing unit which is disposed at an inner portion of the opening/closing plate, and comprises a permanent magnet provided at one side thereof, a movement spring provided at the other side thereof and an opening/closing member disposed between the permanent magnet and the movement spring so as to be intersected with the fluid passage, thereby opening and closing the fluid passage; a brake fluid outlet port which is formed at both sides of the fluid passage formed at the opening/closing plate so as to provide a passage through which the brake fluid in the cylinder is discharged; and an electromagnet which is disposed at an outer circumference of the cylinder so as to be corresponding to the permanent magnet of the fluid passage opening/closing unit and also connected with a vehicle speed sensor.

Preferably, the brake pressure control apparatus further includes a piston control ball which is disposed at a lower surface of the piston so as to prevent the piston from being pushed back over a desired distance when a pressure of the brake fluid is larger than the elastic coefficient of the first spring.

Preferably, the introduction control valve includes a cap-shaped body which is fixed to an upper portion of the fluid passage H and has an introduction portion at an upper surface thereof; an inlet ball which is inserted into the body so as to open and close the introduction port; and a second spring which is disposed between the fluid passage and the inlet ball so as to provide an elastic force to the inlet ball, thereby opening and closing the introduction port.

Preferably, a plurality of introduction control grooves having a different height from each other are formed at an inner surface of the body so as to control a flow of the brake fluid according to a moving degree of the inlet ball.

Preferably, the brake fluid outlet port includes an outlet ball which opens and closes the brake fluid outlet port; and a third spring which supports the outlet ball so as to provide an elastic force to the outlet ball, thereby opening and closing the brake fluid outlet port.

Further, the present invention provides a brake pressure control apparatus including a cylinder of which an upper portion is formed with a connection port connected with a brake line and a lower side surface is formed with an air inlet/outlet port; a solenoid valve which is disposed at a bottom portion of the cylinder so as to be connected with a vehicle speed sensor; a piston which is supported by a first spring and has a piston control ball at a lower surface thereof; an opening/closing plate which is fixed to an upper portion of the piston so as to divide an inner portion of the cylinder and in which a fluid passage H is formed at a center portion thereof; an introduction control valve which is disposed at the fluid passage H formed at the opening/closing plate so as to control a flow of the brake fluid introduced into the cylinder; and a brake fluid outlet port which is formed at both sides of the fluid passage H formed at the opening/closing plate so as to provide a passage through which the brake fluid in the cylinder is discharged.

Preferably, the introduction control valve includes a cap-shaped body which is fixed to an upper portion of the fluid passage H and has an introduction portion at an upper surface thereof; an inlet ball which is inserted into the body so as to open and close the introduction port; and a second spring which is disposed between the fluid passage H and the inlet ball so as to provide an elastic force to the inlet ball, thereby opening and closing the introduction port.

Further, the present invention provides a brake pressure control method, including opening a fluid passage by an electromagnet of a fluid passage opening/closing unit, which is connected with the vehicle speed sensor, in order to control a decompression rate of a brake pressure just before a braked vehicle is stopped; introducing the brake fluid from a brake line into a cylinder through a connection port of the cylinder; controlling a flow of the brake fluid in an introduction control valve provided at one side of the fluid passage; controlling decompression limitation by a first spring or a piston control ball when the controlled brake fluid is introduced and a brake pressure in the brake line is reduced; and returning the controlled brake fluid to the brake line through the brake fluid outlet port, wherein the brake pressure is gradually reduced according to a necessary decompression rate upon ordinary braking or sudden braking.

Preferably, in the controlling of a flow of the brake fluid in an introduction control valve provided at one side of the fluid passage, the inlet ball of the introduction control valve, which is detachably disposed at an introduction port by a second spring, is pushed back so as to introduce the brake fluid, and a plurality of introduction control grooves having a different height from each other are opened in turn according to movement of the inlet ball so as to control the flow of the brake fluid.

Preferably, in the controlling of decompression limitation by a first spring or a piston control ball when the controlled brake fluid is introduced and a brake pressure in the brake line is reduced, when the brake fluid is introduced and the brake pressure is decompressed, introduction limitation upon ordinary braking is determined into an elastic force of the first spring, and the introduction limitation upon ordinary braking is determined into a pressure larger than the elastic force of the first spring by the piston control ball.

Further, the present invention provides a brake pressure control method, including forming an brake fluid introduction space by pushing back a solenoid valve, which is connected with the vehicle speed sensor, in order to control a decompression rate of a brake pressure just before a braked vehicle is stopped; controlling a flow of the brake fluid in an introduction control valve provided at a fluid passage in which the brake fluid is introduced; controlling decompression limitation by a first spring or a piston control ball when a brake pressure of a brake line is decompressed by the controlled brake fluid; and returning the controlled brake fluid to the brake line through the brake fluid outlet port, wherein the brake pressure is gradually reduced according to a necessary decompression rate upon ordinary braking or sudden braking.

### Advantageous Effects

According to the present invention, upon the ordinary braking, it is possible to exhaust the forward inertial force and the backward repulsive force, which are generated when the vehicle is stopped, within a vehicle velocity, thereby stably stopping the vehicle without the braking shock. Thus, it is possible to prevent the fatigue of the driver and also to prevent concentration of the driver from being split.

Further, upon the sudden braking, it is possible to simultaneously generate and offset the strong forward inertial force and the backward repulsive force which are generated when the vehicle is suddenly stopped. Thus, it is possible to reduce the impact applied to the neck and brain due to the forward and rearward vibrations generated by the forward inertial force and backward repulsive force.

### DESCRIPTION OF DRAWINGS

The above and other objects, features and advantages of the present invention will become apparent from the following description of preferred embodiments given in conjunction with the accompanying drawings, in which:

FIG. 1 is an exploded perspective view of a brake pressure control apparatus according to a first embodiment of the present invention.

FIG. 2 is a cross-sectional view taken along a line A-A of FIG. 1.

FIG. 3 is a cross-sectional view taken along a line B-B of FIG. 2.

FIG. 4 is a bottom view of an introduction control valve according to the first embodiment of the present invention.

FIG. 5 is a cross-sectional view taken along a line C-C of FIG. 4.

FIG. 6 is a cross-sectional view taken along a line D-D of FIG. 4.

FIG. 7 is a cross-sectional view of a brake pressure control apparatus according to a second embodiment of the present invention.

FIG. 8 is a flow chart showing a brake pressure control method according to a first embodiment of the present invention.

FIG. 9 is a cross-sectional view showing a state that brake fluid is introduced into the brake pressure control apparatus according to the first embodiment of the present invention.

FIG. 10 is a flow chart showing a brake pressure control method according to a second embodiment of the present invention.

[Detailed Description of Main Elements]

| | |
|---|---|
| 100: brake pressure control apparatus | 101: opening/closing plate |
| 102: cylinder | 102′: introduction space |
| 103: piston | 104: first spring |
| 105: connection port | 106: air inlet/outlet port |
| 107: piston control ball | 110: solenoid valve |
| 200: introduction control valve | 200b: body |
| 201: introduction port | 202: inlet ball |
| 203a, 203b, 203c, 203d: introduction | |
| control groove | |
| 204: second spring | |
| 300: fluid passage opening/closing unit | |
| 301: movement spring | 302: opening/closing member |
| 303: electromagnet | 400: brake fluid outlet port |
| 401: outlet ball | 402: third spring |
| H: fluid passage | |

### BEST MODE

Hereinafter, the embodiments of the present invention will be described in detail with reference to accompanying drawings.

<Construction of Pressure Control Apparatus>

### First Embodiment

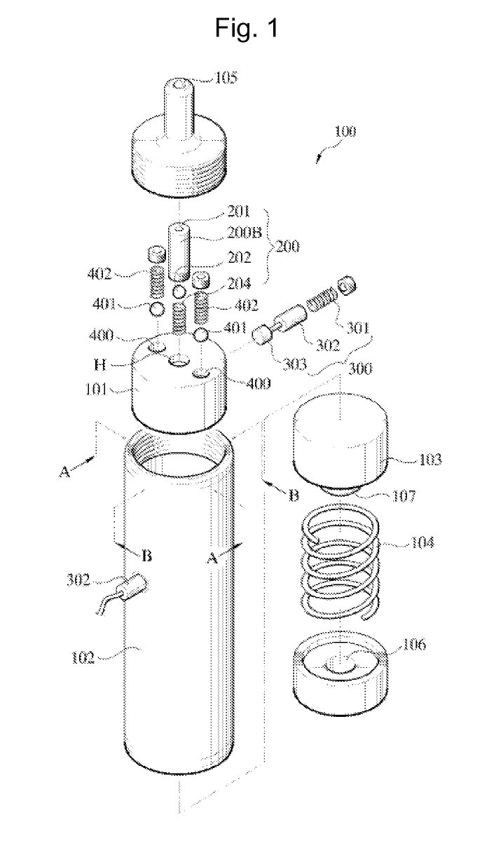

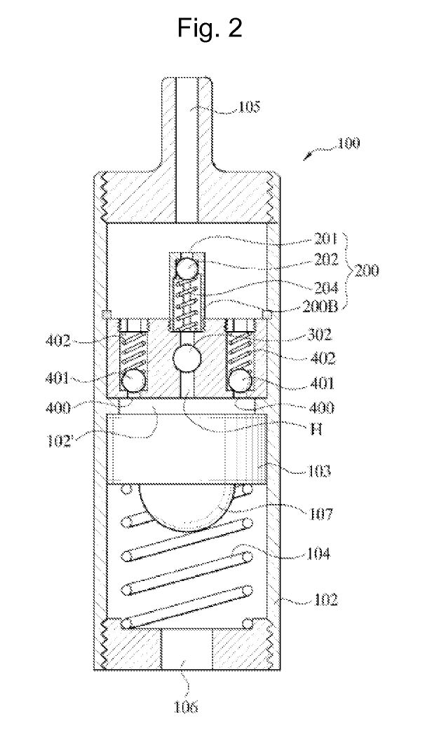

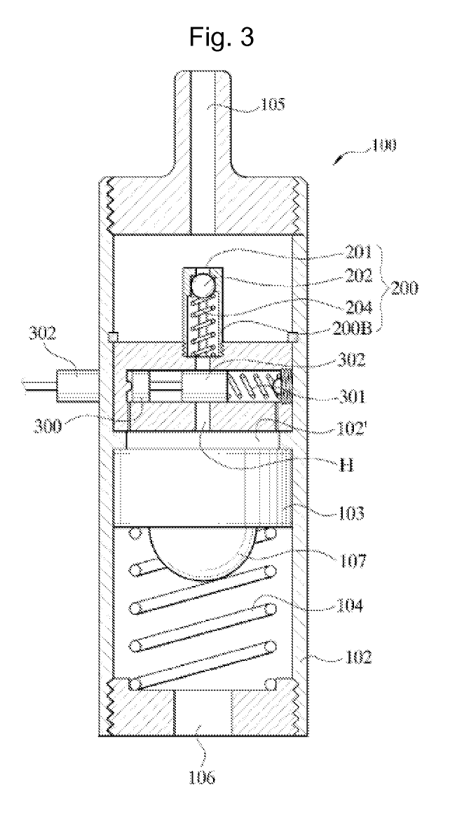

FIG. 1 is an exploded perspective view of a brake pressure control apparatus according to a first embodiment of the present invention, FIG. 2 is a cross-sectional view taken along a line A-A of FIG. 1, and FIG. 3 is a cross-sectional view taken along a line B-B of FIG. 2.

As shown in FIGS. 1 and 3, a brake pressure control apparatus 100 according to a first embodiment of the present invention includes a cylinder 102, a piston 103, an opening/closing plate 101, an introduction control valve 200, a fluid passage opening/closing unit 300, a brake fluid outlet port 400 and an electromagnet 303.

The cylinder 102 according to the first embodiment of the present invention is to provide a brake fluid introduction space 102′ in which brake fluid is introduced and the piston 103 is reciprocated by a pressure introducing the brake fluid. The cylinder 102 is formed into a cylindrical shape of which an upper portion is formed with a connection port 105 connected with a brake line so as to introduce the brake fluid and a lower surface is formed with an air inlet/outlet port 106. Herein, the brake fluid introduction space 102′ is a space which is formed at a lower portion of the cylinder 102 so as to be defined by movement of the piston 103 and through which the brake fluid is introduced.

The piston 103 according to the first embodiment of the present invention is pushed by a pressure of the introduced brake fluid, and then discharges the brake fluid in the cylinder 102 by an elastic force of a first piston 104 when the pressure of the brake fluid is reduced. The piston 103 is disposed at a bottom portion of the cylinder 102 so as to be supported by the first spring 104 contacted with a bottom surface of the cylinder 102 which is formed with the air inlet/outlet port 106 and a piston control ball 107 which is provided at a lower surface of the piston 103.

The first spring 104 of the present invention functions to support the piston 103. It has the same elastic coefficient as a minimum brake pressure necessary for stopping a vehicle.

The piston control ball 107 of the present invention functions to prevent the piston 103 from being pushed back over a desired distance when the pressure of the brake fluid is larger than the elastic coefficient of the first spring 104. The piston control ball 107 is formed into a hemispherical shape. Since the piston control ball 107 is pushed by the strong pressure and collided with the bottom surface of the cylinder 102, it is formed of a shock-resistant material, preferably, a rubber material.

The opening/closing plate 101 according to the first embodiment of the present invention is disposed in the cylinder 102 so as to divide an inner portion of the cylinder 102. The opening/closing plate 101 has an outer diameter corresponding to an inner diameter of the cylinder 102. A fluid passage H through which the brake fluid is introduced is formed at a center portion of the opening/closing plate 101. Herein, a brake fluid outlet port 400 is formed at both sides of the fluid passage H so as to be parallel with the fluid passage H. The brake fluid outlet port 400 will be detailedly described later.

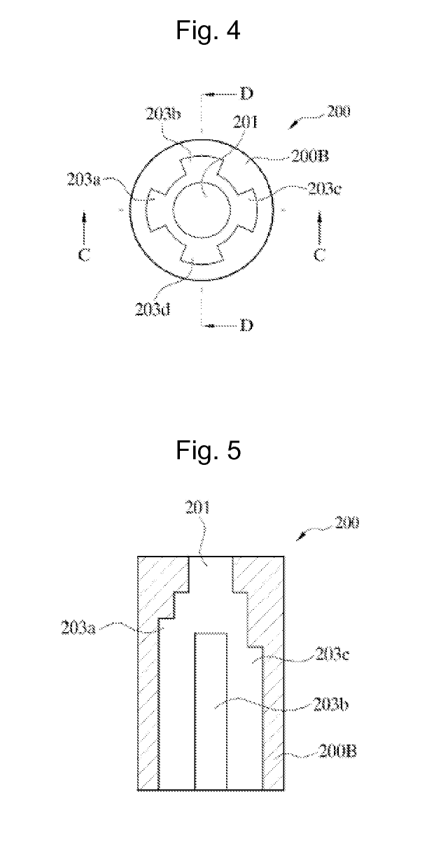

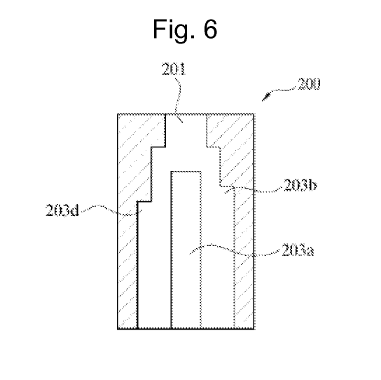

FIG. 4 is a bottom view of an introduction control valve according to the first embodiment of the present invention, FIG. 5 is a cross-sectional view taken along a line C-C of FIG. 4, and FIG. 6 is a cross-sectional view taken along a line D-D of FIG. 4. The introduction control valve 200 according to the first embodiment of the present invention is provided at an upper side of the opening/closing plate 101 so as to adjust a flow the brake fluid introduced into the fluid passage H and thus to control a decompression rate of the brake pressure. The introduction control valve 200 includes a body 200B, an inlet ball 202 and a second spring 204. The body 200B is formed into a cap shape which is fixed to an upper portion of the fluid passage H and formed with an introduction portion through which the brake fluid is introduced. As shown in FIGS. 4 to 6, at an inner surface of the body 200B, there are formed a plurality of introduction control grooves 203a, 203b, 203c and 203d having a different height from each other. The introduction control grooves 203a, 203b, 203c and 203d have a different height from each other so that the number of the introduction control grooves 203a, 203b, 203c and 203d to be opened is changed by movement of the inlet ball 202, thereby controlling the flow of the brake fluid. The inlet ball 202 according to the present invention is inserted into the body 200B so as to be supported by a second spring 204 supported at one side of the fluid passage H, thereby opening and closing the introduction port 201 of the introduction control valve 200 by an introduction pressure of the brake fluid and an elastic force of the second spring 204.

The fluid passage opening/closing unit 300 according to the first embodiment of the present invention is disposed in the opening/closing plate 101 so as to be transversely intersected with the fluid passage H, thereby opening and closing the fluid passage H. The fluid passage opening/closing unit 300 includes a permanent magnet 300 which is provided at one side thereof, and a movement spring 301 which is provided at the other side thereof so as to provide an elastic force. Further, an opening/closing member 302 having a larger width than the fluid passage H is provided between the permanent magnet 300 and the movement spring 301. The brake fluid outlet port 400 according to the first embodiment of the present invention is formed at both sides of the fluid passage H so that the brake fluid introduced into the brake fluid introduction space 102′ can be discharged. An outlet ball 401 is provided at the brake fluid outlet port 400 so as to open and close the brake fluid outlet port 400, and a third spring 402 is provided so as to support the outlet ball 401 and also to provide an elastic force to the outlet ball 401, thereby opening and closing the brake fluid outlet port 400.

The electromagnet 303 according to the first embodiment of the present invention is connected with a vehicle speed sensor through an ECU (Electronic Control Unit) and disposed at a position corresponding to the permanent magnet 300 of the fluid passage opening/closing unit 300. The electromagnet 303 functions to generate a magnetic field responding to the vehicle speed sensor so as to push the permanent magnet 300 of the fluid passage opening/closing unit 300, thereby opening the fluid passage H.

### Second Embodiment

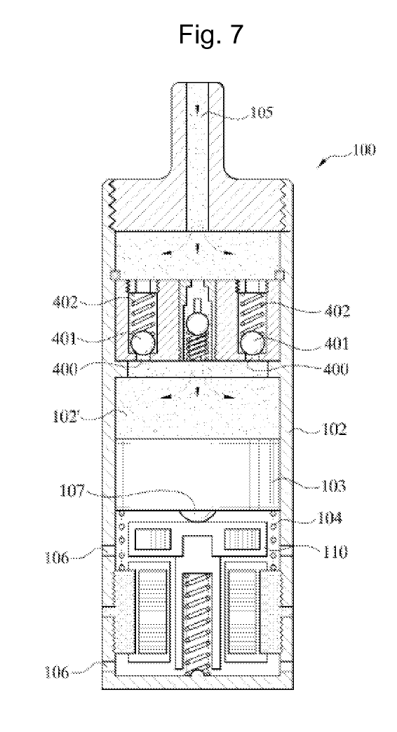

FIG. 7 is a cross-sectional view of a brake pressure control apparatus according to a second embodiment of the present invention. A brake pressure control apparatus 100 according to a second embodiment of the present invention includes a cylinder 102, a piston 103, an opening/closing plate 101, an introduction control valve 200, and a brake fluid outlet port 400. Herein, the cylinder 102, the opening/closing plate 101 and the brake fluid outlet port 400 have the same construction as those in the first embodiment.

In the cylinder 102 according to the second embodiment of the present invention, when a current is applied to a coil of a solenoid valve 110, a movable iron piece is pulled by an electromagnet. If the valve is opened by the pulled movable iron piece, a brake fluid introduction space 102′ is provided so that the brake fluid having a stronger pressure than a first spring 104 can be supplied. The piston 103 is disposed at a lower side of the cylinder 102 so as to be supported by the first spring 104 which is provided at an upper portion of a supporting portion formed at one side of the cylinder 102 adjacent to an upper portion of the solenoid valve 110, and a piston control ball 107 is provided at a lower surface of the piston 103. Further, the piston 103 is slid by a pressure of the introduced brake fluid, an operation of the solenoid valve 110 and the first spring 104 so as to introduce and discharge the brake fluid into/from the brake fluid introduction space 102′ of the cylinder 102.

On the whole, the introduction control valve 200 according to the second embodiment of the present invention has the same construction as that according to the first embodiment. However, unlike in the first embodiment, the introduction control valve 200 is inserted into the fluid passage H.

<Brake Pressure Control Method>

### First Embodiment

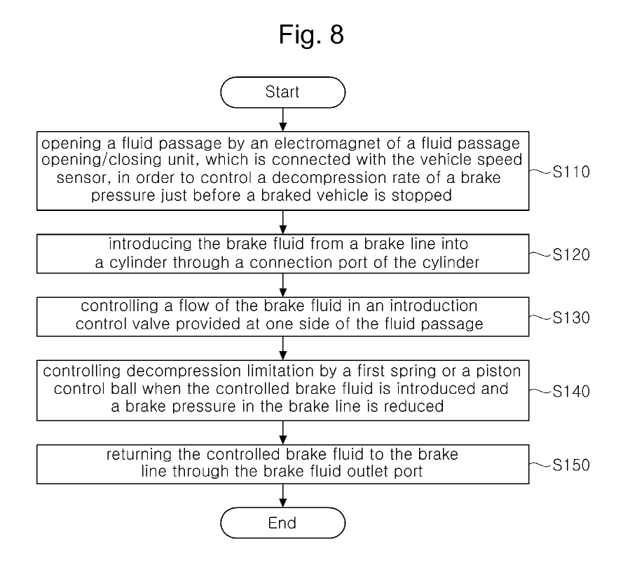

FIG. 8 is a flow chart showing a brake pressure control method according to a first embodiment of the present invention. A brake pressure control method according to a first embodiment of the present invention utilizes the brake pressure control apparatus 100 according to the first embodiment of the present invention. As shown in FIG. 8, in order to control a decompression rate of the brake pressure, the fluid passage H is opened by the electromagnet 303 of the fluid passage opening/closing unit 300, which is connected with the vehicle speed sensor (S110). Herein, the opening of the fluid passage H is performed by the movement of the permanent magnet 300 of the fluid passage opening/closing unit 300 due to the magnetic field of the electromagnet 303 connected with the vehicle speed sensor. At this time, the opening/closing member 302 which is connected with the permanent magnet 300 and intersected with the fluid passage H is pushed back by the movement of the permanent magnet 300, thereby opening the fluid passage H. It takes about 1 to 1.5 seconds to open the fluid passage H. This is to provide time for preventing the sudden stopping state from being occurred in a moment when a vehicle is generally stopped and thus exhausting the forward inertial force and the backward repulsive force. Also, this is to provide time for offsetting the forward inertial force and the backward repulsive force.

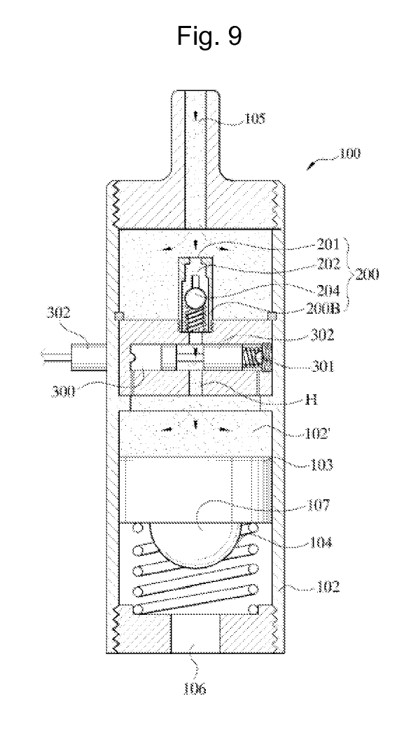

FIG. 9 is a cross-sectional view showing a state that brake fluid is introduced into the brake pressure control apparatus according to the first embodiment of the present invention. As shown in FIG. 9, the brake fluid is introduced from the brake line connected with the cylinder 102 through the connection port 105 into the brake fluid introduction space 102′ of the cylinder 102 (S120).

Then, the introduction flow of the brake fluid is controlled by the introduction control valve 200 provided at one side of the fluid passage H (S130). Herein, in the introduction control valve 200, the inlet ball 202 which is detachably disposed at the introduction port 201 by the second spring 204 is pushed back by the brake fluid having a higher pressure than the elastic coefficient of the second spring 204, and thus the brake fluid is introduced into the brake fluid introduction space 102′. At this time, the plurality of introduction control grooves 203a, 203b, 203c and 203d having a different height from each other are opened in turn according to the movement of the inlet ball 202 so as to control the flow of the brake fluid. In other words, if the inlet ball 202 is moved only slightly, only the highest introduction control groove 203a is opened, and thus the introduction flow of the brake fluid is small. If the inlet ball 202 is moved maximally, all of the introduction control grooves 203a, 203b, 203c and 203d are opened, and a large amount of brake fluid is introduced for a short time period. As described above, upon the ordinary braking, the flow of the brake fluid is controlled and thus the brake fluid is gradually introduced so as to decompress the braking pressure, thereby softly decelerating the vehicle during a short moment until the vehicle is stopped. Therefore, the vehicle can obtain the vehicle speed (time) necessary for exhausting the forward inertial force and the backward repulsive force without the sudden braking state.

When the controlled brake fluid is introduced into the brake fluid introduction space 102′ and the brake pressure in the brake line is reduced, the decompression limitation is controlled by the first spring 104 of the piston 103 (S140). That is, in order to prevent the problem of the new inertial force by decompressing the brake pressure when the brake fluid is introduced into the brake fluid introduction space 102′, the introduction limitation of the brake fluid is determined by the calculated elastic force of the first spring 104 into a level that the pressure of the brake line is maintained at a minimum stopping pressure.

Furthermore, upon the sudden braking, the remained braking pressure which overcomes the calculated elastic force of the first spring 104 is prevented from being introduced into the brake fluid introduction space 102′ by the piston control ball 107, and thus the brake line can maintains a stopping pressure necessary for the sudden braking and the inclined position of the vehicle.

Finally, the brake fluid introduced into the brake fluid introduction space 102′ is returned to the brake line through the brake fluid outlet port 400 (S150). Herein, in the brake fluid outlet port 400, the outlet ball 401 supported by the third spring 402 is pushed back by the elastic force of the first spring 104 having a higher elastic force than the elastic coefficient of the third spring 402, thereby opening the brake fluid outlet port 400 and thus discharging the brake fluid. For an example, if the operation of the brake pedal is stopped in order to restart the vehicle after stopping the vehicle for a moment, the pressure of the brake like is reduced, and the brake fluid introduced into the brake fluid introduction space 102′ pushes the third spring 402 having the relatively smaller elastic force than the first spring 104 using the elastic force of the first spring 104, and thus the brake fluid in the brake fluid introduction space 102′ is returned to the brake line having a small pressure through the brake fluid outlet port 400. Accordingly, the brake pressure control apparatus 100 is in an initial state for the re-operation thereof.

In the above-mentioned brake pressure control method, when the vehicle is suddenly stopped, the permanent magnet 300 is moved by the electromagnet 303 responding to a signal of the vehicle speed sensor, and the fluid passage H is opened by the opening/closing member 302 of the fluid passage opening/closing unit 300 at a vehicle speed of 1 km/hr to 2 km/hr just before the vehicle is stopped, and the brake pressure having a strong braking pressure is gradually introduced for a short moment. Thus, the decompression of the brake fluid is occurred so that the time for generating the forward inertial force of the vehicle is extended and the time for generating the backward repulsive force as the restoring force of a suspension system is reduced. Since the forward inertial force and the backward repulsive force are generated at the same time and offset, the vehicle can softly stopped without the braking shock.

By the above-mentioned brake pressure control method, since the decompression rate is changed according to the brake pressure upon braking, the brake pressure can be gradually reduced for a short moment until the vehicle is stopped.

### Second Embodiment

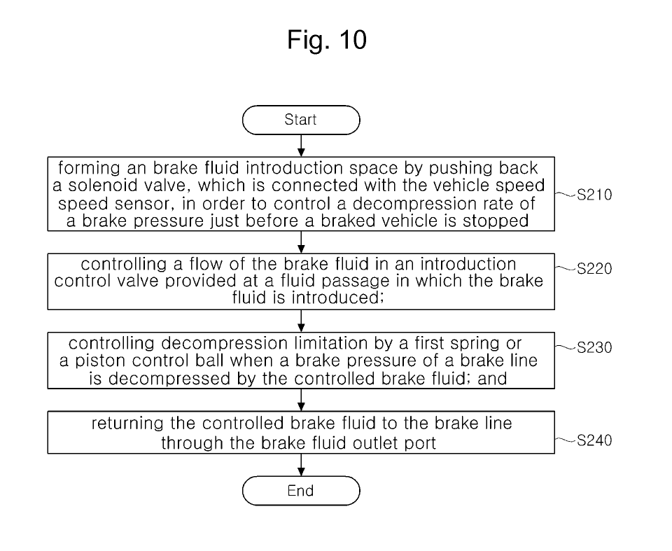

FIG. 10 is a flow chart showing a brake pressure control method according to a second embodiment of the present invention. A brake pressure control method according to a first embodiment of the present invention utilizes the brake pressure control apparatus 100 according to the second embodiment of the present invention. As shown in FIG. 10, in order to control the decompression rate of the brake pressure, the solenoid valve 110 connected with the vehicle speed sensor is pushed back so as to form the brake fluid introduction space 102′ in which the brake fluid is introduced (S210). At this time, the movable iron piece is moved back by the magnetic field generated when the current is applied to the coil of the solenoid valve 110 connected with the vehicle speed sensor, thereby forming the brake fluid introduction space 102′ which receives the brake fluid having a larger pressure than the elastic force of the first spring 104.

Then, a flow of the brake fluid is controlled in the introduction control valve 200 disposed at one side of the fluid passage H through which the brake fluid is introduced (S220). Herein, the introduction control valve 200 controls the flow of the brake fluid so that the brake fluid has a higher pressure than the elastic coefficient of the second spring 204 which supports the inlet ball 202 contacted with the introduction port 201, thereby introducing the brake fluid through the introduction port 201. The plurality of introduction control grooves 203a, 203b, 203c and 203d having a different height from each other are opened in turn according to the movement of the inlet ball 202 so as to control the flow of the brake fluid. In other words, if the inlet ball 202 is moved only slightly, only the highest introduction control groove 203a is opened, and thus the introduction flow of the brake fluid is small. If the inlet ball 202 is moved maximally, all of the introduction control grooves 203a, 203b, 203c and 203d are opened, and a large amount of brake fluid is introduced for a short time period. As described above, the flow of the brake fluid is controlled and thus the brake fluid is gradually introduced so as to decompress the braking pressure, thereby softly decelerating the vehicle during a short moment until the vehicle is stopped. Therefore, the vehicle can obtain the vehicle speed (time) necessary for exhausting the forward inertial force and the backward repulsive force without the sudden braking state.

When the controlled brake fluid is introduced into the brake fluid introduction space 102′ and the brake pressure in the brake line is reduced, the decompression limitation is controlled by the first spring 104 of the piston 103 (S230). That is, in order to prevent the problem of the new inertial force by decompressing the brake pressure, the introduction limitation of the brake fluid is determined by the calculated elastic force of the first spring 104 into a level that the pressure of the brake line is maintained at a minimum stopping pressure.

Furthermore, upon the sudden braking, the remained braking pressure which overcomes the calculated elastic force of the first spring 104 is prevented from being introduced into the brake fluid introduction space 102′ by the piston control ball 107, and thus the brake line can maintains a stopping pressure necessary for the sudden braking and the inclined position of the vehicle.

Finally, the brake fluid introduced into the brake fluid introduction space 102′ is returned to the brake line through the brake fluid outlet port 400 (S240). Herein, in the brake fluid outlet port 400, the outlet ball 401 supported by the third spring 402 is pushed back by the elastic force of the first spring 104 having a higher elastic force than the elastic coefficient of the third spring 402, thereby opening the brake fluid outlet port 400 and thus discharging the brake fluid. For an example, if the operation of the brake pedal is stopped in order to restart the vehicle after stopping the vehicle for a moment, the pressure of the brake like is reduced, and the brake fluid introduced into the brake fluid introduction space 102′ pushes the third spring 402 having the relatively smaller elastic force than the first spring 104 using the elastic force of the first spring 104, and thus the brake fluid in the brake fluid introduction space 102′ is returned to the brake line having a small pressure through the brake fluid outlet port 400. Accordingly, the brake pressure control apparatus 100 is in an initial state for the re-operation thereof.

By the above-mentioned brake pressure control method, since the decompression rate is changed according to the brake pressure upon braking, the brake pressure can be gradually reduced for a short moment until the vehicle is stopped.

### Modified Embodiment

The brake pressure control apparatus 100 and the method thereof according to the present invention may use air-pressure instead of the brake fluid.

### INDUSTRIAL APPLICABILITY

According to the present invention, upon the ordinary braking, it is possible to exhaust the forward inertial force and the backward repulsive force, which are generated when the vehicle is stopped, within a vehicle velocity, thereby stably stopping the vehicle without the braking shock. Thus, it is possible to prevent the fatigue of the driver and also to prevent concentration of the driver from being split.

Further, upon the sudden braking, it is possible to simultaneously generate and offset the strong forward inertial force and the backward repulsive force which are generated when the vehicle is suddenly stopped. Thus, it is possible to reduce the impact applied to the neck and brain due to the forward and rearward vibrations generated by the forward inertial force and backward repulsive force.

While the present invention has been described with respect to the specific embodiments, it will be apparent to those skilled in the art that various changes and modifications may be made without departing from the spirit and scope of the invention as defined in the following claims.

1. A brake pressure control apparatus comprising:
a cylinder (102) of which an upper portion is formed with a connection port (105) connected with a brake line and a lower surface is formed with an air inlet/outlet port (106);
a piston (103) which is supported by a first spring (104) disposed at a bottom surface of the cylinder (102);
an opening/closing plate (101) which is fixed to an upper portion of the piston (103) so as to divide an inner portion of the cylinder (102) and in which a fluid passage H is formed at a center portion thereof;
an introduction control valve (200) which is disposed at an upper portion of the fluid passage H formed at the opening/closing plate (101) so as to control a flow of the brake fluid introduced into the cylinder (102) according to a brake pressure;
a fluid passage opening/closing unit (300) which is disposed at an inner portion of the opening/closing plate (101), and comprises a permanent magnet (300) provided at one side thereof, a movement spring (301) provided at the other side thereof and an opening/closing member (302) disposed between the permanent magnet (300) and the movement spring (301) so as to be intersected with the fluid passage H, thereby opening and closing the fluid passage H;
a brake fluid outlet port (400) which is formed at both sides of the fluid passage H formed at the opening/closing plate (101) so as to provide a passage through which the brake fluid in the cylinder (102) is discharged; and
an electromagnet (303) which is disposed at an outer circumference of the cylinder (102) so as to be corresponding to the permanent magnet (300) of the fluid passage opening/closing unit (300) and also connected with a vehicle speed sensor.

2. The brake pressure control apparatus according to claim 1, further comprising a piston control ball (107) which is disposed at a lower surface of the piston (103) so as to prevent the piston (103) from being pushed back over a desired distance when a pressure of the brake fluid is larger than the elastic coefficient of the first spring (104).

3. The brake pressure control apparatus according to claim 1, wherein the introduction control valve (200) comprises,
a cap-shaped body (200B) which is fixed to an upper portion of the fluid passage H and has an introduction portion (201) at an upper surface thereof;
an inlet ball (202) which is inserted into the body (200B) so as to open and close the introduction port (201); and
a second spring (204) which is disposed between the fluid passage H and the inlet ball (202) so as to provide an elastic force to the inlet ball (202), thereby opening and closing the introduction port (201).

4. The brake pressure control apparatus according to claim 3, wherein a plurality of introduction control grooves (203a), (203b), (203c) and (203d) having a different height from each other are formed at an inner surface of the body (200B) so as to control a flow of the brake fluid according to a moving degree of the inlet ball (202).

5. The brake pressure control apparatus according to claim 1, wherein the brake fluid outlet port (400) comprises,
an outlet ball (401) which opens and closes the brake fluid outlet port (400); and
a third spring (402) which supports the outlet ball (401) so as to provide an elastic force to the outlet ball (401), thereby opening and closing the brake fluid outlet port (400).

6. A brake pressure control apparatus comprising:
a cylinder (102) of which an upper portion is formed with a connection port (105) connected with a brake line and a lower side surface is formed with an air inlet/outlet port (106);
a solenoid valve (110) which is disposed at a bottom portion of the cylinder (102) so as to be connected with a vehicle speed sensor;
a piston (103) which is supported by a first spring (104) and has a piston control ball (107) at a lower surface thereof;
an opening/closing plate (101) which is fixed to an upper portion of the piston (103) so as to divide an inner portion of the cylinder (102) and in which a fluid passage H is formed at a center portion thereof;
an introduction control valve (200) which is disposed at the fluid passage H formed at the opening/closing plate (101) so as to control a flow of the brake fluid introduced into the cylinder (102); and
a brake fluid outlet port (400) which is formed at both sides of the fluid passage H formed at the opening/closing plate (101) so as to provide a passage through which the brake fluid in the cylinder (102) is discharged.

7. The brake pressure control apparatus according to claim 6, wherein the introduction control valve (200) comprises,
a cap-shaped body (200B) which is fixed to an upper portion of the fluid passage H and has an introduction portion (201) at an upper surface thereof;
an inlet ball (202) which is inserted into the body (200B) so as to open and close the introduction port (201); and
a second spring (204) which is disposed between the fluid passage H and the inlet ball (202) so as to provide an elastic force to the inlet ball (202), thereby opening and closing the introduction port (201).

8. A brake pressure control method, comprising:
opening a fluid passage H by an electromagnet (303) of a fluid passage opening/closing unit (300), which is connected with the vehicle speed sensor, in order to control a decompression rate of a brake pressure just before a braked vehicle is stopped;
introducing the brake fluid from a brake line into a cylinder (102) through a connection port 105 of the cylinder (102);
controlling a flow of the brake fluid in an introduction control valve (200) provided at one side of the fluid passage H;
controlling decompression limitation by a first spring (104) or a piston control ball (107) when the controlled brake fluid is introduced and a brake pressure in the brake line is reduced; and
returning the controlled brake fluid to the brake line through the brake fluid outlet port (400),
wherein the brake pressure is gradually reduced according to a necessary decompression rate upon ordinary braking or sudden braking.

9. The brake pressure control method according to claim 8, wherein, in the controlling of a flow of the brake fluid in an introduction control valve (200) provided at one side of the fluid passage H, the inlet ball (202) of the introduction control valve (200), which is detachably disposed at an introduction port (201) by a second spring (204), is pushed back so as to introduce the brake fluid, and a plurality of introduction control grooves (203a), (203b), (203c) and (203d) having a different height from each other are opened in turn according to movement of the inlet ball (202) so as to control the flow of the brake fluid.

10. The brake pressure control method according to claim 8, wherein, in the controlling of decompression limitation by a first spring (104) or a piston control ball (107) when the controlled brake fluid is introduced and a brake pressure in the brake line is reduced, when the brake fluid is introduced and the brake pressure is decompressed, introduction limitation upon ordinary braking is determined into an elastic force of the first spring (104), and the introduction limitation upon ordinary braking is determined into a pressure larger than the elastic force of the first spring (104) by the piston control ball (107).

11. A brake pressure control method, comprising:
forming an brake fluid introduction space by pushing back a solenoid valve (110), which is connected with the vehicle speed sensor, in order to control a decompression rate of a brake pressure just before a braked vehicle is stopped;
controlling a flow of the brake fluid in an introduction control valve (200) provided at a fluid passage H in which the brake fluid is introduced;
controlling decompression limitation by a first spring (104) or a piston control ball (107) when a brake pressure of a brake line is decompressed by the controlled brake fluid; and
returning the controlled brake fluid to the brake line through the brake fluid outlet port (400),
wherein the brake pressure is gradually reduced according to a necessary decompression rate upon ordinary braking or sudden braking.
